(19) United States
(12) Patent Application Publication
(10) Pub. No.: US 2021/0375111 A1
(43) Pub. Date: Dec. 2, 2021

(54) NOTIFICATION DEVICE, WEARABLE DEVICE AND NOTIFICATION METHOD

(71) Applicant: Aurismart Technology Corporation, Taipei City (TW)

(72) Inventor: Kuang-Chiu HUANG, Taipei City (TW)

(21) Appl. No.: 17/331,726

(22) Filed: May 27, 2021

(30) Foreign Application Priority Data
May 28, 2020 (TW) 109117898
May 28, 2020 (TW) 109206633

(51) Int. Cl. G08B 21/02; G08B 21/18

(52) U.S. Cl. CPC G08B 21/02; G08B 21/182

(57) ABSTRACT

A notification device includes a pressure sensor, a microcontroller and an output device. The pressure sensor is used to detect the environment to provide a pressure signal. The microcontroller is connected to the pressure sensor to receive the pressure signal. The microcontroller is used to calculate a dynamic threshold of the pressure signal in a period of time. When a magnitude of the pressure signal is greater than the dynamic threshold, the microcontroller sends a first feedback signal to the output device. The output device is connected to the microcontroller. The output device is used to provide a first feedback action according to the first feedback signal.

### BACKGROUND

### Field of Disclosure

The present disclosure relates to a notification device and wearable device with a notification device.

### Description of Related Art

In some workplaces, it is inconvenient to communicate directly through voice. For example, there are hearing impaired people in the workplace, or there is loud noise in the workplace. In these situations, workers remain isolated from the sound and it is not inconvenient to communication. If you use other communication aids in the market, it may affect working. In such regard, how to provide a portable and instant notification device is one of the problems that people in the related fields want to solve.

### SUMMARY

An aspect of the present disclosure is related to a notification device

According to one embodiment of the present disclosure, a notification device includes a pressure sensor, a microcontroller and an output device. The pressure sensor is configured to detect the environment to provide a pressure signal. The microcontroller is connected to the pressure sensor to receive the pressure signal. The microcontroller is configured to calculate a dynamic threshold of the pressure signal in a period of time. When a magnitude of the pressure signal is greater than the dynamic threshold, the microcontroller sends a first feedback signal to the output device. The output device is connected to the microcontroller. The output device is configured to provide a first feedback action according to the first feedback signal.

In one or more embodiments, the output device comprises a light emitting device, a vibrator, a sound amplifier or a text icon display device.

In one or more embodiments, the pressure sensor is a sound sensor. The dynamic average value is an average volume in the period of time.

In some embodiments, the notification device further includes a distance sensor connected to the microcontroller and a circuit board. The sound sensor and the distance sensor are integrated on the circuit board.

In some embodiments, the notification device further includes a server. The server is connected to the microcontroller through a network. The microcontroller transmits the sound signal to the server. The server recognizes and classifies the type of the sound signal to send a second feedback signal to the microcontroller according to the type of the sound signal. The output device provides a second feedback action according to the second feedback signal.

In some embodiments, the server further includes a sound recognition module, a classification module and a processor. The sound recognition module is configured to recognize the sound signal. The classification module is configured to classify the type of the sound signal. The processor is configured to provide the second feedback signal according to the type of the sound signal.

An aspect of the present disclosure is related to a wearable device.

According to one embodiment of the present disclosure, a wearable device includes the mentioned notification device and a cloth. The pressure sensor, the microcontroller and the output device of the notification device are arranged on the cloth.

An aspect of the present disclosure is related to a notification method, which can be performed by the mentioned notification device.

According to one embodiment of the present disclosure, a notification method includes following operations. Environment is detected to provide a pressure signal. The pressure signal is processed to obtain a dynamic average value of the pressure signal in a period of time. A dynamic threshold is configured according to the dynamic average value. Whether a current volume of sound is greater than the dynamic threshold is determined. If the dynamic average value is greater than the threshold, a feedback action is transmitted to an output device, a feedback action is provided by the output device according to the feedback signal.

In one or more embodiments, the pressure signal is a sound signal, the dynamic average value is an average volume of the sound signal in the period of time.

An aspect of the present disclosure is related to a notification method, which can be performed by the mentioned notification device.

According to one embodiment of the present disclosure, a notification method includes following operations. Environment is detected to provide an analog sound signal. The analog sound signal is soundly recolonized and a type of the analog sound signal is classified. A feedback signal is outputted according the type of the analog sound signal. A feedback action is provided by an output device according to the feedback signal.

In summary, the present disclosure provides a notification device, a wearable device using the notification device, and a corresponding notification method to notify the user in real time according to the environmental volume, so that the user can easily perceive changes in the environment.

It is to be understood that both the foregoing general description and the following detailed description are by examples, and are intended to provide further explanation of the invention as claimed.

### BRIEF DESCRIPTION OF THE DRAWINGS

The advantages of the present disclosure are to be understood by the following exemplary embodiments and with reference to the attached drawings. The illustrations of the drawings are merely exemplary embodiments and are not to be considered as limiting the scope of the present disclosure.

FIG. 1 illustrates a block diagram of a notification device according to an embodiment of the present disclosure;

FIG. 2 illustrates a flowchart of a notification method according to an embodiment of the present disclosure;

FIG. 3 illustrates a block diagram of a notification device according to an embodiment of the present disclosure;

FIG. 4 illustrates a block diagram of a server according to an embodiment of the present disclosure;

FIG. 5 illustrates a flowchart of a notification method provided by a notification device according to an embodiment of the present disclosure;

FIG. 6 illustrates a flowchart of a training method of training a sound recognition module according to an embodiment of the present disclosure;

FIG. 7 illustrates a flowchart of a training method of training a classification module according to an embodiment of the present disclosure; and

FIGS. 8-10 respectively illustrate a front view of a wearable device, a back view of the wearable device and a perspective view of the inside of the pocket of a wearable device according to an embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Also, the same labels may be regarded as the corresponding components in the different drawings unless otherwise indicated. The drawings are drawn to clearly illustrate the connection between the various components in the embodiments, and are not intended to depict the actual sizes of the components.

In addition, terms used in the specification and the claims generally have the usual meaning as each terms are used in the field, in the context of the disclosure and in the context of the particular content unless particularly specified. Some terms used to describe the disclosure are to be discussed below or elsewhere in the specification to provide additional guidance related to the description of the disclosure to specialists in the art.

The phrases “first,” “second,” etc., are solely used to separate the descriptions of elements or operations with the same technical terms, and are not intended to convey a meaning of order or to limit the disclosure.

Additionally, the phrases “comprising,” “includes,” “provided,” and the like, are all open-ended terms, i.e., meaning including but not limited to.

Further, as used herein, “a” and “the” can generally refer to one or more unless the context particularly specifies otherwise. It will be further understood that the phrases “comprising,” “includes,” “provided,” and the like used herein indicate the stated characterization, region, integer, step, operation, element and/or component, and does not exclude additional one or more other characterizations, regions, integers, steps, operations, elements, components and/or groups thereof.

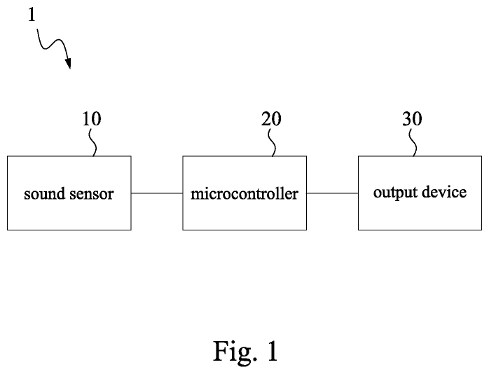

Reference is made by FIG. 1. FIG. 1 illustrates a block diagram of a notification device 1 according to an embodiment of the present disclosure. As shown in FIG. 1, the notification device 1 includes a sound sensor 10, a microcontroller 20 and an output device 30. Through the notification device 1, the user can be notified in real time according to changes in the environment.

The sound sensor 10 is used to detect environment to receive sound signals in the environment. When the notification device 1 is configured in an environment such as a warehouse or a factory, the received sound signal is, for example, the sound of engineering equipment or the human voice of other workers, and the received sound signal is an analog signal. In some embodiments, the sound sensor 10 is, for example, a microphone sensing module (for example, condenser microphone), or may be a condenser microphone sensing module simply arranged in an array.

A microcontroller (microcontroller, or named as microcontroller unit, MCU for short) 20 is connected to the sound sensor 10. The microcontroller 120 has the advantages of small size, easy portability, and can be configured to implement simple arithmetic functions. The sound sensor 10 can transmit the sound signal to the microcontroller 20, and the sound signal from the sound sensor 10 is simply processed by the microcontroller 20. The microcontroller 20 can also integrate a function for judging the volume of the sound signal. Therefore, the microcontroller 20 can record a sound signal over a period of time and provide a feedback signal according to the volume change of the sound signal.

The output device 30 is connected to the microcontroller 20 to provide a feedback action based on the feedback signal. The output device 30 can include a light emitting device, a vibrator, a sound amplifier, or a text icon display device. The text icon device directly reminds the user more intuitively by displaying text or other icons. The text icon display device includes a small portable display.

Therefore, the notification device 1 can detect the environment through the sound sensor 10 to provide sound signals. The microcontroller 20 connected to the sound sensor 10 processes the dynamic average value of the sound signals over a period of time. The dynamic average value refers to the average volume of the sound signals in the previous period of time. Based on the dynamic average value, a dynamic threshold can be predetermined. If a volume of the current sound signal is greater than the dynamic threshold calculated by the dynamic average value of the previous period, it means that the environment has changed, there may be danger or there is a need for communication around, and the microcontroller 20 provides a feedback signal to the output device 30, so that the output device 30 provides a feedback action to notify the user.

In some embodiments, instead of the sound sensor 10, other types of pressure sensors can also be used as the notification device 1. A kind of pressure sensor is the sound sensor 10, which is used to sense and convert the sound pressure change in the sound transmission in the environment into sound signals and then calculate a dynamic average value to obtain a dynamic threshold. In some embodiments, other types of pressure sensors such as air pressure sensors can be used as the notification device 1. For example, the air pressure sensor can sense the dynamic average value of the air pressure during a period of time. Once the current air pressure value is greater than the dynamic average value calculated in the previous period, the microcontroller 20 can send a feedback signal to enable the output device 30 to provide a feedback action to immediately notify the user who uses the notification device 1.

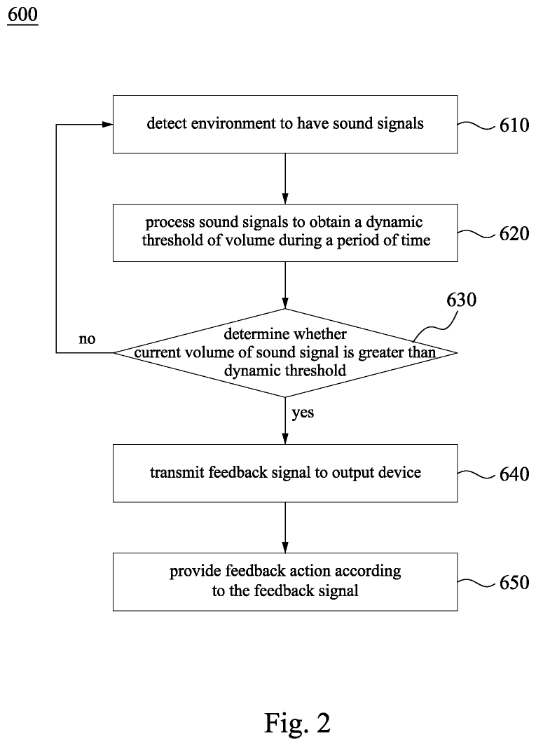

Reference is made by FIG. 2 to further describe how to notify the user by the notification device. FIG. 2 illustrates a flowchart of a notification method 600 according to an embodiment of the present disclosure. The notification method 600 includes operation 610-650.

In operation 610, the sound sensor 10 of the notification device 1 can be used to detect environment around the user to obtain sound signals during a period of time.

In operation 620, the sound signals can be processed by the microcontroller 20 connected to the sound sensor 10 to obtain the dynamic threshold during a period of time. The microcontroller 20 can first calculate the dynamic average value of the volumes of the sound signals during a period of time according to the sound signals. For example, the sound sensor 10 can obtain a dynamic average value of the volumes during the period from 3 seconds ago to 1 second ago. After the notification device 1 is activated, the dynamic average value may change in times continuously.

According to the dynamic average value, the microcontroller 20 can define the dynamic threshold of the volumes of the sound signals in different times, so as to determine whether the volumes of the sound signals have a large change in a short time. In some embodiments, the dynamic threshold can be set as the dynamic average value. In some embodiments, it can be set that the dynamic threshold is different from the dynamic average value according to the magnitude of the dynamic average value. For example, if the dynamic average value of the volumes of the sound signal is less than a specific decibel (dB), the dynamic threshold is set to a value greater than the dynamic average value; and if the dynamic average value of the volumes of the sound signals is greater than the specific decibel, the set dynamic threshold is directly equal to the dynamic average value.

Through operation 620, the dynamic average value of the volumes of the received sound signal is set. In the process 630, it can be determined whether a volume of a current sound signal is greater the dynamic threshold according to the current volume of the sound signal. If yes, the operation 640 is entered, and a feedback signal is sent to the output device 30. If not, return to operation 610 and continue to detect the environment to provide sound signals.

For example, in a specific embodiment, the dynamic average volume of the volumes of the sound signals from 3 seconds ago to 1 second ago is calculated by the microcontroller 20 calculates and is a specific decibel value (e.g., 60 dBs), and the dynamic average value of the volumes of the sound signals is set as the dynamic threshold by the microcontroller 20 (operation 620). Then, once the current volume of the sound signal is greater than the dynamic threshold (for example, greater than 60 dBs), the situation corresponds to the determination of operation 630 as yes, the operation 640 is entered and the microcontroller 20 can provide a feedback signal to the output device 30 in real time.

Therefore, in the operation 650, the output device 30 can provide an appropriate feedback action based on the feedback signal from the microcontroller 20 to notify the user who uses the notification device 1. The notification method 600 can be implemented by a mobile device. For example, mobile devices such as smart phones have a microphone, a processor, and a vibrator configured to vibrate the phone. The installation of an application (APP) is performed on the smart phone for the notification, and it enables the microphone to act as the sound sensor 10, the processor of the mobile phone functions as the microcontroller 20, and the vibrator of the mobile phone acts as the output device 30 to provide notification vibration feedback action.

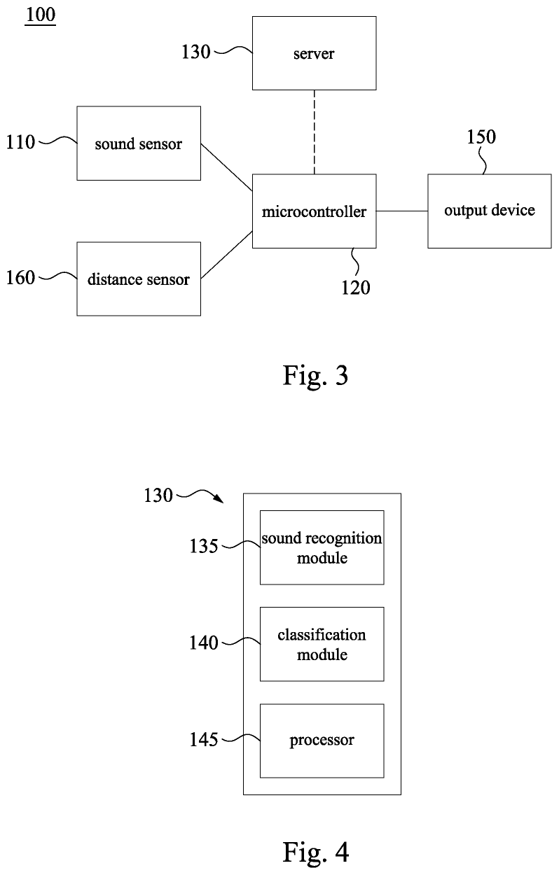

Reference is made by FIG. 3. FIG. 3 illustrates a block diagram of a notification device 100 according to an embodiment of the present disclosure. The notification device 100 is built on the basis of the notification device 1 and can further provide intelligent notification and alert functions in addition to the function of the notification device 1. As shown in FIG. 3, the notification device 100 includes a sound sensor 110, a microcontroller 120, a server 130, an output device 150, and a distance sensor 160. In this embodiment, the sound sensor 110, the output device 150, and the distance sensor 160 are connected to the microcontroller 120, and the server 130 is located remotely, for example, connected to the microcontroller 120 by a network. The server 130 can be used for complex computation. Since the server 130 can be located remotely, when the notification device 100 is operated, only the sound sensor 110, the microcontroller 120, the output device 150, and the distance sensor 160 need to be carried. In some embodiments, the network is, for example, a wireless network shared by a mobile phone of the user. In some embodiments, the microcontroller 120 can be connected to the network through Bluetooth communication. In some embodiments, the network may be another type of wireless network (Wi-Fi), such as Zigbee. In some embodiments, the network may also be narrow band Internet of things (narrow band Internet of things, NBIoT) of a fourth-generation mobile communication technology (4G) or LTE-M technology. In some embodiments, the network may be provided by the fifth-generation mobile communication technology (5G) to achieve faster transmission rate and interaction.

The sound sensor 110 is similar to the sound sensor 10 in FIG. 1. The sound sensor 110 is used to detect the environment to receive sound signals in the environment. For example, when the notification device 100 is used in an environment such as a warehouse or a factory, the received sound signals are, for example, the sounds of engineering equipment or the human voice of other workers, which are analog signals. Specifically, in some embodiments, the sound sensor 110 is, for example, a microphone sensing module. The microphone sensing module is, for example, a condenser microphone. In some embodiments, the condenser microphone sensing modules can also be simply arranged in an array.

In order to facilitate analysis, the received analog sound signals can be processed to filter noises after the sound signals from the environment are received by the sound sensor 110. In some embodiments, other devices used for filtering noise can also be provided on the sound sensor 110.

The microcontroller 120 is similar to the microcontroller 20 in FIG. 1. The microcontroller 120 is connected to the sound sensor 110. The microcontroller 120 has the advantages of small size, easy portability, and can be used to implement simple arithmetic functions. Furthermore, the microcontroller 120 can be connected to a remote server 130 by a network. Through the connection with the microcontroller 120, the sound sensor 110 can transmit the sound signals to the microcontroller 120. In some embodiments, the network can be provided by, for example, a mobile phone.

The server 130 is located remotely and used to perform more complicated operations. Reference is made by FIGS. 3 and 4. FIG. 4 illustrates a block diagram of the server 130 according to an embodiment of the present disclosure. In this embodiment, the server 130 includes a sound recognition module 135, a classification module 140, and a processor 145. In some embodiments, the sound recognition module 135, the classification module 140, and the processor 145 are computer components in the server 130. In some embodiments, the sound recognition module 135, the classification module 140, and the processor 145 can be integrated into the same hardware.

The sound recognition module 135 is configured for recognizing sound signals. The classification module 140 is configured to classify types of the recognized sound signals. The processor 145 is configured to provide a feedback signal according to the types of the sound signals. For details, please refer to specific operation methods below. Through the remote transmission of the network, the microcontroller 120 can be used to receive the feedback signal from the server 130 remotely.

The output device 150 is connected to the microcontroller 120 to provide feedback actions according to the feedback signals. The output device 150 is similar to the output device 30 in FIG. 1 and includes a light emitting device, a vibrator, a sound amplifier, or a text icon display device. The text icon display device includes a small portable display. In order to cope with the inconvenient environment for communicating with voice, in some embodiments, the feedback action of the output device 150 does not include voice/sound feedback.

The distance sensor 160 is connected to the microcontroller 120 to detect the distance between the notification device 100 and an object. For example, the distance sensor 160 is, for example, an ultrasonic distance sensing device. In some embodiments, the distance sensor 160 uses infrared rays for distance sensing, or uses millimeter-wave radar or sub-millimeter-wave radar. Due to the used short wavelength, it can have a wider sensing range to detect objects in a great angular range.

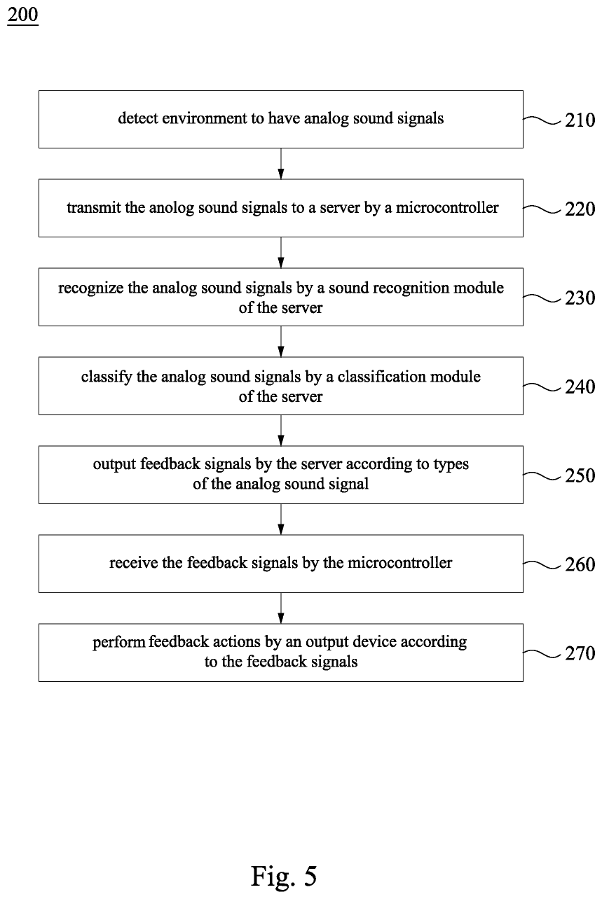

Reference is made by FIG. 5. FIG. 5 illustrates a flowchart of a notification method 200 provided by a notification device 100 according to an embodiment of the present disclosure.

In operation 210 of the notification method 200, the sound sensor 110 of the notification device 100 detects environment to obtain analog sound signals.

Following the operation 210, in the operation 220, the analog sound signals are transmitted by the microcontroller 120 to the server 130 through, for example, a network.

In operation 230, the analog sound signals are recognized by the sound recognition module 135 of the server 130. Through the recognition of the sound recognition module 135, the server 130 can obtain the sounds contained in the analog sound signal, such as the warning sound from a person, the specific content of the warning sound, and/or the sound of engineering equipment.

In operation 240, types of the analog sound signals can be classified through the classification module 140 of the server 130. In the operation 250, feedback signals are outputted by the server 130 according to the types of the sound signals. In other words, a type of the sound signal can correspond to a kind of feedback signal. A types of the sound signal is classified according to the response after the sound signal is received, and the type is used for warning of danger or call communication, for example.

In some embodiments, the sound signals in the working environment can be classified into plurality of types, and each of the types of the sound signals corresponds to a condition, and the condition corresponds to one of feedback actions. A number of the types of sound signals is finite and can be customized and introduced according to the conditions.

For example, in some implementations, there is only one type “dangerous” of the sound signals. The sound signal is received by the notification device 100 (operation 210) and uploaded to the server (operation 220), a recognition of the sound signal is completed (operation 230), and then it learns that the content of the sound signal is to inform the user that it is dangerous (e.g., the content of the sound signal can be a sound of working equipment or human voice), and the sound signal can be classified as “dangerous” by the notification device 100 at this time, so that a corresponding feedback signal is outputted by the server 130 to the output device 150 to notify the user of the notification device 100 that the user is at risk.

Specifically, in another practical example, there are six types of sound signals including dodging to the left if danger appears, dodging to the right if danger appears, vibrating, other types of danger, moving to the right, and reminding to be called by someone. For example, a sound signal is received by the notification device 100 (operation 210) and uploaded to the server (operation 220), the recognition of the sound signal is completed (operation 230), and then the content of the sound signal is to notify the user that the right side is dangerous and the user should dodge to the left. At this time, the sound signal is classified into the type “dodging to the left if danger appears” by the notification device 100 (operation 240). Subsequently, a feedback signal about dodging to the left is outputted by the server 130 (operation 250).

In some embodiments, the distance sensor 160 can also be used to provide information about the environment near around the user of the notification device 100, so that much accurate judgments can be provided by the server 130. For example, in some embodiments, a large-size work equipment moves from the rear right to the user of the notification device 100. At the same time, the sound signals of the large-size equipment sound are detected by the sound sensor 110 and an approach of an object from the rear right is detected by the distance sensor 160, so that the server 130 can identify and classify that the type of the sound signal is about dodging to the left according to the above information, thereby providing a feedback signal about dodging to the left.

Continued with operation 250, in the operation 260, the feedback signal from the server 130 is received by the microcontroller 120 remotely via the network.

In the operation 270, a feedback action is performed by the output device 150 connected to the microcontroller 120 according to the received feedback signal. For example, the output device 150 can be a vibrator placed on the left and right shoulders of the user. When the feedback signal about dodging to the left is received by the microcontroller 120, the vibrator on the left shoulder of the user vibrates, so that the vibrator on the left shoulder of the user vibrates in real time through the sense of touch and a warning is issued to the user of the notification device 100.

In some embodiments, the notification device 100 can be further connected to a console. The console can be used to manage one or more notification devices 100 or wearable devices with the notification devices 100 at the same time. For example, the console can actively send a feedback signal to a specific one of the notification devices 100 to directly drive the output device to perform a warning. Accordingly, the proactive notification provided in the above manner can further strengthen the warning function of the notification device 100. In some embodiments, the console can further configure one or more notification devices 100 into different groups, so as to notify a specific group or all notification devices 100 in different conditions in environment with loud-noise.

In this embodiment, the sound recognition module 135 and the classification module 140 can be trained through machine learning to provide customized recognition and classification of sound signals in response to different types of working environments. In details, please refer to following discussion.

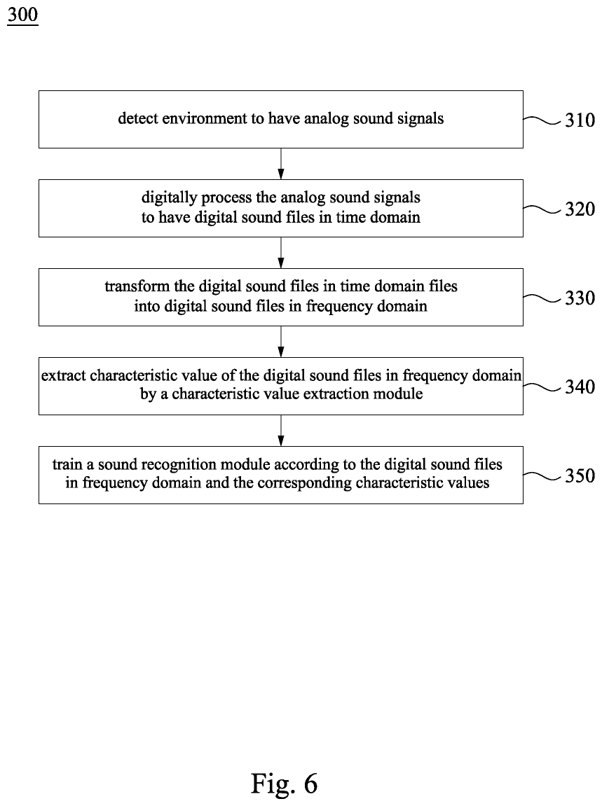

Reference is made by FIG. 6. FIG. 6 illustrates a flowchart of a training method 300 of training a sound recognition module 135 according to an embodiment of the present disclosure.

As illustrated in figures, in operation 310, the sound sensor 110 is used to detect the environment to obtain analog sound signals. The user of the notification device 100 can select different detection environments according to actual needs.

In some embodiments, the sound sensor 110 can detect the signal according to the signal detection theory (SDT) by dynamically detecting the sound.

In operation 320, after the sound sensor 110 detects the analog sound signals in the environment, the analog sound signals are converts into digital sound files in time domain through digital processing. In some embodiments, the digital processing can be performed by the microcontroller 120. In some embodiments, the digital processing can also be performed remotely by the server 130. In some embodiments, the digital sound files in time domain can be further divided into several specific sound blocks according to time through frame blocking processing and the signals in individual sound blocks are processed and analyzed.

Continued with operation 320, in operation 330, the digital sound files in time domain is transformed into digital sound files in frequency domain. Specifically, the digital sound files in time domain can be transformed into digital sound files in frequency domain through the server 130 or other computer devices connected to the server 130 in a manner of fast Fourier transform (FFT). In some embodiments, by creating digital sound files in frequency domain, a spectrogram, which corresponds to the amplitudes of the digital sound files in time domain at different frequencies at different times, can be further obtained.

Continued with operation 330, in operation 340, characteristic values of the digital sound files in frequency domain are extracted through a sound characteristic value extraction module. The sound characteristic value extraction module is configured in the server 131. The characteristic values of the digital sound files in frequency domain correspond to different kinds of sounds. For example, the sound from engineering equipment and human voice have different characteristics, and these characteristics response in the spectrum or spectrogram of the sound, for example. By analyzing the spectrum or spectrogram of the digital sound files in frequency domain, the characteristic values of the digital sound files in frequency domain can be extracted from the spectrum or spectrogram, so as to distinguish the difference between the sound produced by the engineering equipment and the human voice.

For example, the sound characteristic value extraction module can be performed by the use of Mel-Frequency Cepstral Coefficients (MFCCs) method. Through the calculation module of sound characteristic value extraction module, the digital sound files in frequency domain can be converted into the corresponding Mel-Frequency Cepstrum (MFC) to obtain the corresponding Mel-Frequency Cepstrum Coefficients (MFCCs). The Mel-Frequency cepstrum coefficients can be used as the characteristic value of the digital sound files in frequency domain, so that what kinds of the digital sound files in frequency domain can be obtained, the kinds of the digital sound files in frequency domain are, for example, the sound of engineering equipment or human voice. In some embodiments, Deep Neural Networks (DNN) technology in the field of artificial intelligence can be used in the sound characteristic value extraction module to extract the characteristic values of the digital sound files in frequency domain. Deep neural network technology has a good performance in image recognition. Therefore, conceptually, the digital sound files in frequency domain can be converted into an image, and the sound corresponding to the image of the digital sound files in frequency domain can be identified by image recognition to obtain the corresponding characteristic value.

Specifically, in one embodiment, the server 130 includes a convolutional neural network (CNN) model. In the deep neural network technology, the convolutional neural network module can effectively realize the function of image recognition. A sequence of spectrograms provided by other sounds can be pre-input to the convolutional neural network model, so that the training of image recognition of the convolutional neural network model can be performed and completed. One sequence of spectrograms may refer to the frequency amplitude distribution diagrams at different times arranged in a time sequence. For example, a plurality of sets of corresponding sequence of spectrograms can be provided as the basis for image recognition for the sound of working equipment or human voice. In some embodiments, the sound used to train the convolutional neural network model is sampled in the actual working environment, so as to create a customized recognition scheme according to the actual environment. Therefore, after the learning of image recognition for the convolutional neural network model is completed, the convolutional neural network model can receive input of another sequence of spectrograms. The convolutional neural network model obtains the similar sound of another sequence of spectrograms through image recognition and then outputs a corresponding characteristic value. According to requirements of the user of the notification device 100, analog sound signals in the environment can be detected, the analog sound signals can be converted into digital sound files in frequency domain, and then a training is performed based on the files of existing human voices or sound of tools and instruments by inputting the digital sound files in frequency domain.

Therefore, another implementation manner of operation 340 can be implemented as follows. First, convert the digital sound file in frequency domain into a sequence of spectrograms. The spectrogram shows changes in the amplitudes of different frequencies over time. Here, a sequence of frequency amplitude distribution diagrams of digital sound files in frequency domain at different times can be output. Then, a sequence of spectrograms of the digital sound file in frequency domain is input into the convolutional neural network model in the sound characteristic value extraction module, and the characteristic value of the digital sound file in frequency domain can be output by the convolutional neural network model.

In operation 350, the sound recognition module 135 can be trained according to the digital sound files in frequency domain and their characteristic value. The training of the sound recognition module 135 can be applied by deep neural networks in the field of artificial intelligence. Each of the characteristic value of the digital sound file in frequency domain corresponds to a kind of the human voice or sounds tools and instruments. When a characteristic value of a digital sound file in frequency domain indicates that it is a human voice, the message content corresponding to the digital sound file in frequency domain is further input to the sound recognition module 135 to train the sound recognition module 135. When the characteristic value of the digital sound file in frequency domain indicates that it is the sound of a tools and instruments, corresponding condition information can be provided. Therefore, when the trained sound recognition module 135 receives the sound signal, it can identify whether the sound signal is a human voice or the sound of a tool or an instrument. If the sound signal is a human voice, the content of the message to be conveyed can be determined. If the sound signal is sound of a tool or an instrument, a corresponding situational information can be provided. In some embodiments, the microcontroller 120 can be directly connected to a single-chip computer, and the edge calculation of sound recognition can be realized on the premise of being easy to carry. For example, a single-chip computers include raspberry pi.

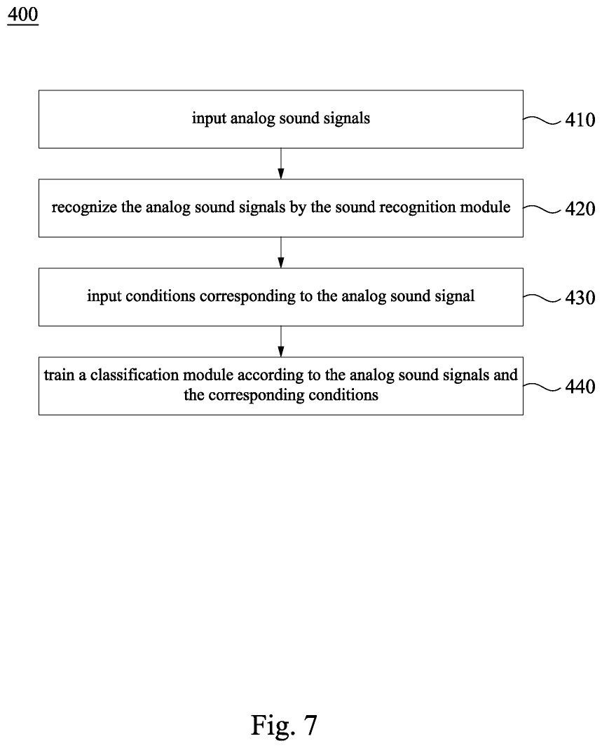

FIG. 7 illustrates a flowchart of a training method 1400 of training a classification module 140 according to an embodiment of the present disclosure. Similar to the voice recognition module 135, the classification module 140 can also achieve customized training through a deep neural network. The classification module 140 is used to distinguish the types of different analog sound signals to provide appropriate feedback signals.

In operation 410, analog sound signals are input. In operation 420, the input of the analog sound signals is recognized by, for example, the sound recognition module 135.

Then, in operation 430, the condition information corresponding to the analog sound signals are input. For example, when an analog sound signal is input, the analog sound signal can be recognized that is about message of dodging to the left from someone, and the corresponding condition is to dodge to the left at this time.

In operation 440, the classification module 140 can be trained according to the analog sound signals and their corresponding conditions. Specifically, the recognized analog sound signals are used as input, the corresponding specific conditions are used as the training target, and the classification module 140 can be trained to classify the recognized analog sound signal into different conditions. The different conditions are, for example, the condition of dodging to the left as mentioned above. Different conditions correspond to different types of the sound signals. Therefore, the notification device 100 is substantially integrated with a wireless network and can also personalize the setting of artificial intelligence identification parameters, so that the server 130 can receive different condition information for retraining. This is an implementation of the Internet of Thing (IoT) architecture of the overall service of the notification device 100 of the present disclosure. In addition, the microcontroller 120 can also implement a warning function beyond the Internet of Things architecture. For example, the microcontroller 120 integrated with the function of judging the volume of the sound signal can be used to detect abnormal changes in the environmental volume, so as to send another feedback signal for warning notification. The specific flow is similar to flowchart in FIG. 2, and the notification device 100 can perform the same function as the notification device 1. Therefore, in an environment where there is no network, the notification device 100 can also implement a warning notification function.

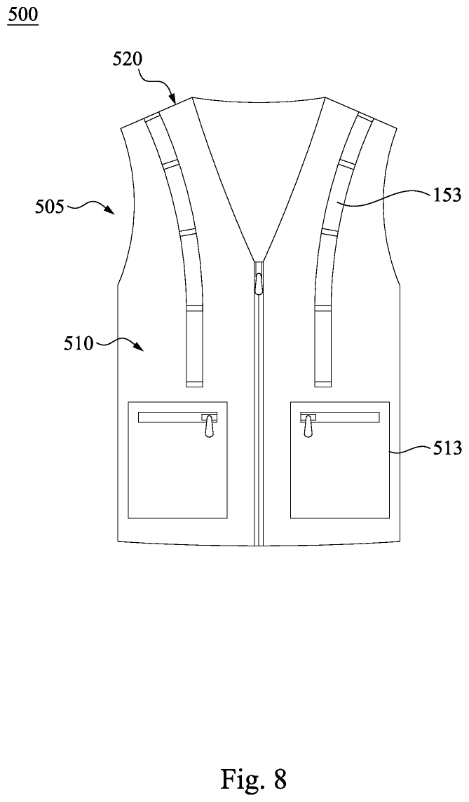

Reference is made by FIGS. 8,9 and 10. FIGS. 8-10 respectively illustrate a front view of a smart vest 500, which is a wearable device, a back view of the wearable device and a perspective view of the inside of the pocket of the wearable device according to an embodiment of the present disclosure. In this embodiment, the notification device 100 is installed on a vest 505 to serve as a smart vest 500. In some embodiments, other cloth beyond the vest 505 can also be used.

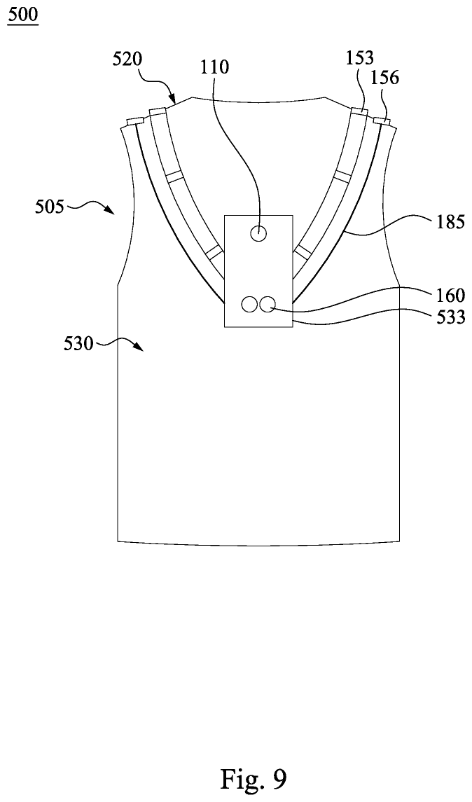

Please refer to FIGS. 8 and 9. As shown in figures, the smart vest 500 includes a front 510, a back 530, and a shoulder 520 connecting the front 510 and the back 530. The front 510 is provided with a pocket 513 to accommodate the mobile phone and provide internet access. The back 530 of the smart vest 500 is also provided with a pocket 533. The pocket 533 is used to house and fix the components of the notification device 100, which includes the sound sensor 110, the distance sensor 160 and the circuit board 170.

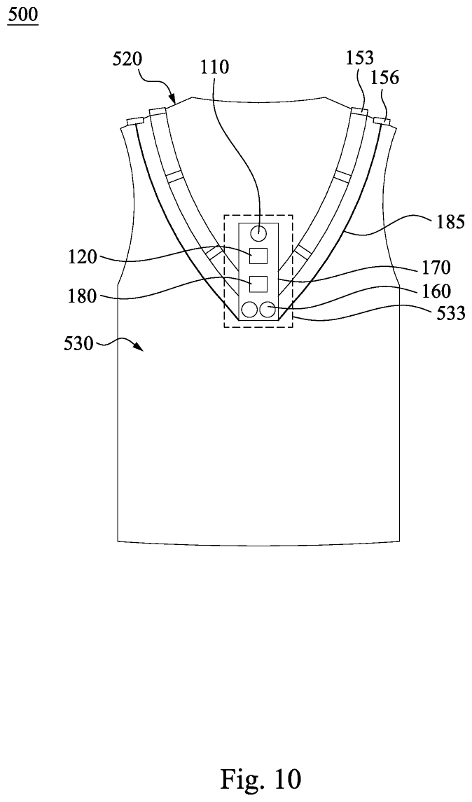

As shown in FIG. 10, the sound sensor 110 of the notification device 100, the microcontroller 120, the power supply module 180 for supplying power, and the distance sensor 160 are integrated on the support plate 170. The power supply module 180 includes a battery and a switch. The wires can be integrated on the top, inside the interlayer, or on the opposite side of the circuit board 170.

In this embodiment, the sound sensor 110, the distance sensor 160 and the circuit board 170 are arranged in the pocket 533 on the back 530 of the smart vest 500. Since the eyes of the user are not easy to look at the back, the sound sensor 110 and the distance sensor 160 used for detecting environment are arranged on the back 530 of the smart vest 500, which can better play the role of the notification device 100 to detect danger and issue a warning. In some embodiments, the exposed parts of the sound sensor 110 and the distance sensor 160 are provided with a waterproof structure to adapt to different environmental changes. In this embodiment, the output device 150 provided on the smart vest 500 includes a light bar 153 and a vibrator 156. The vibrator 156 is connected to the circuit board 170 through a wire 185.

In summary, the present disclosure provides a notification device and a wearable device using the notification device. The notification device can detect the volume of the environment in a period of time, so as to notify the user in real time when the volume of the environment changes. The notification device can also connect to the server remotely by the microcontroller using the network. It is easy to carry and the server can recognize and classify the received sound signals to provide feedback based on the type of the sound signals. The type of the sound signal is, for example, human voice or sound of engineering equipment. The wearable device is, for example, a smart vest combined with a notification device, which is convenient to wear. By installing output devices such as a vibrator and a light bar on it, the user can easily perceive changes in the environment by means other than sound, which is conducive to real-time communication and warning. The notification device is also set to facilitate customized training to provide more accurate recognition and warning effects in different working environments.

Although the present invention has been described in considerable detail with reference to certain embodiments thereof, other embodiments are possible. Therefore, the spirit and scope of the appended claims should not be limited to the description of the embodiments contained herein. In view of the foregoing, it is intended that the present invention cover modifications and variations of this invention provided they fall within the scope of the following claims.

1. A notification device, comprising:
a pressure sensor configured to detect environment to provide a pressure signal;
a microcontroller connected to the pressure sensor to receive the pressure signal, wherein the microcontroller is configured to calculate a dynamic threshold of the pressure signal in a period of time; and
an output device connected to the microcontroller, wherein the output device is configured to provide a first feedback action according to a first feedback signal that is sent by the microcontroller to the output device when a magnitude of the pressure signal is greater than the dynamic threashold.

2. The notification device of claim 1, wherein the output device comprises a light emitting device, a vibrator, a sound amplifier or a text icon display device.

3. The notification device of claim 1, wherein the pressure sensor is a sound sensor, the pressure signal is a second signal, the dynamic threshold is configured according to a dynamic average value and the dynamic average value is an average volume in the period of time.

4. The notification device of claim 3, further comprising a distance sensor connected to the microcontroller and a circuit board, wherein the sound sensor and the distance sensor are integrated on the circuit board.

5. The notification device of claim 3, further comprising a server, wherein the server is connected to the microcontroller through a network, the microcontroller transmits the sound signal to the server, the server recognizes and classifies a type of the sound signal to send a second feedback signal to the microcontroller according to the type of the sound signal, and the output device provides a second feedback action according to the second feedback signal.

6. The notification device of claim 5, wherein the server further comprises:
a sound recognition module configured to recognize the sound signal;
a classification module configured to classify the type of the sound signal; and
a processor configured to provide the second feedback signal according to the type of the sound signal.

7. A wearable device, comprising:
the notification device of claim 1; and
a cloth, wherein the pressure sensor, the microcontroller and the output device of the notification device are arranged on the cloth.

8. A notification method, comprising:
detecting environment to provide a pressure signal;
processing the pressure signal to obtain a dynamic average value of the pressure signal in a period of time;
configuring a dynamic threshold according to the dynamic average value;
determining whether a current pressure signal is greater than the dynamic threshold;
transmitting a feedback signal to an output device if the current pressure signal is greater than the dynamic threshold; and
providing a feedback action by the output device according to the feedback signal.

9. The notification method of claim 8, wherein the pressure signal is a sound signal, the dynamic average value is an average volume of the sound signal in the period of time.

10. A notification method, comprising:
detecting environment to obtain an analog sound signal;
soundly recolonizing the analog sound signal and classifying a type of the analog sound signal;
outputting a feedback signal according the type of the analog sound signal; and
providing a feedback action by an output device according to the feedback signal.
